(19) United States
(12) Patent Application Publication
(10) Pub. No.: US 2013/0207813 A1
(43) Pub. Date: Aug. 15, 2013

(54) SAFETY WARNING LIGHT

(71) Applicant: Albert Pun Tak NG, Hong Kong (CN)

(72) Inventor: Albert Pun Tak NG, Hong Kong (CN)

(21) Appl. No.: 13/743,455

(22) Filed: Jan. 17, 2013

(30) Foreign Application Priority Data
Feb. 10, 2012 (CN) 201220043000.6

(51) Int. Cl. G08B 5/36

(52) U.S. Cl. CPC G08B 5/36
USPC 340/815.45; 340/815.4

(57) ABSTRACT

The invention provides a safety warning light. The safety warning light includes a light-guiding soft plastic body on which a wearing band and an electronic device placing portion are of integrated design and which is mainly composed of PU material, wherein one side of the light-guiding soft plastic body is equipped with a reflective coating, and one end or two ends of the light-guiding soft plastic body are equipped with light sources. The safety warning light can provide visibility in many ways sand many angles by using plastic with special light-guiding and light-scattering function, adding the reflective coating on bottom of a plastic armband and using high-brightness LED at two ends of the light-guiding plastic as light source. Compared with existing related like products, the safety warning light has much higher brightness and broader visibility.

### TECHNICAL FIELD OF THE INVENTION

The invention relates to a warning light, and in particular to a warning light worn on arm or leg.

### BACKGROUND OF THE INVENTION

A safety warning light has been widely applied to sporting goods, for example, the safety warning light is worn on arm or other parts of the body of sporter to provide a clearly visible safety precaution for other people, especially drivers, so that they can see the sporter to avoid accident. The design of many existing safety warning lights that cloth is used for covering and there is no plastic enclosing electronic part as waterproof protection makes the safety warning lights inconvenient to use in rainy day. Because exposed part is covered with cloth, and there is no plastic enclosing electronic part and light-emitting part, sweat of user tends to accumulate in cloth and cannot be cleaned, which causes the light to stink after a long time use.

### SUMMARY OF THE INVENTION

For solving the problem in the traditional art, the invention provides a safety warning light. The safety warning light includes a light-guiding soft plastic body on which a wearing band and an electronic device placing portion are of integrated design and which is mainly composed of PU material, wherein one side of the light-guiding soft plastic body is equipped with a reflective coating, and one end or two ends of the light-guiding soft plastic body are equipped with light sources.

As a further improvement of the invention, the light source is a high-brightness LED light source.

As a further improvement of the invention, switch of the safety warning light is a soft silica gel button switch.

As a further improvement of the invention, battery door of the safety warning light is equipped with a battery door structure which can be opened by a coin.

As a further improvement of the invention, the battery door which can be opened by a coin is the one which can be opened by a coin of one-Yuan face value.

As a further improvement of the invention, one end of the safety warning light is equipped with a two-window plastic buckle, and the other end is equipped with Velcro.

As a further improvement of the invention, front end of the Velcro adopts material with light-reflecting function.

The invention has the following beneficial effect: the safety warning light can provide visibility in many ways sand many angles by using plastic with special light-guiding and light-scattering function, adding the reflective coating on bottom of a plastic armband and using high-brightness LED at two ends of the light-guiding plastic as light source. Compared with existing related like products, the safety warning light has much higher brightness and broader visibility.

The design feature of the safety warning light is adopting integrated design and using plastic with light-guiding and light-scattering function as body to enclose the whole safety warning light and all electronic parts; compared with the design of related like products that cloth is used for covering and there is no plastic enclosing electronic part as waterproof protection, the advantages of this design are: a more effective waterproof and cushioning design is available; user can use the safety warning light at ease in any weather conditions, even in rainy day. Besides, the novel integrated design does not use cloth to cover, so user can clean sweat with soft cloth to keep the safety warning light clean and sanitary.

With the integrated design of the safety warning light, when user needs to stop on the road for asking for help because of different reasons, the safety warning light becomes a light emitting rod, so as to attract passerby to offer help.

The design feature of the safety warning light is adopting a big soft silica gel button as switch which is waterproof, easy to operate and convenient to print brand mark.

The design feature of the safety warning light is having a battery door which can be opened by a coin, so it is convenient to replace battery.

The design feature of the safety warning light is adopting a two-window plastic buckle and elastic Velcro, and using material with light-reflecting function as front end of the Velcro; through the two-window plastic buckle and elastic Velcro, the safety warning light can be fixed on arms and legs of different sizes.

### BRIEF DESCRIPTION OF THE DRAWINGS

FIG. 1 shows a front view of the invention;

FIG. 2 shows a back view of the invention;

FIG. 3 shows a left view of the invention;

FIG. 4 shows a right view of the invention;

FIG. 5 shows a top view of the invention;

FIG. 6 shows a bottom view of the invention; and

FIG. 7 shows an internal structure of each component of the invention.

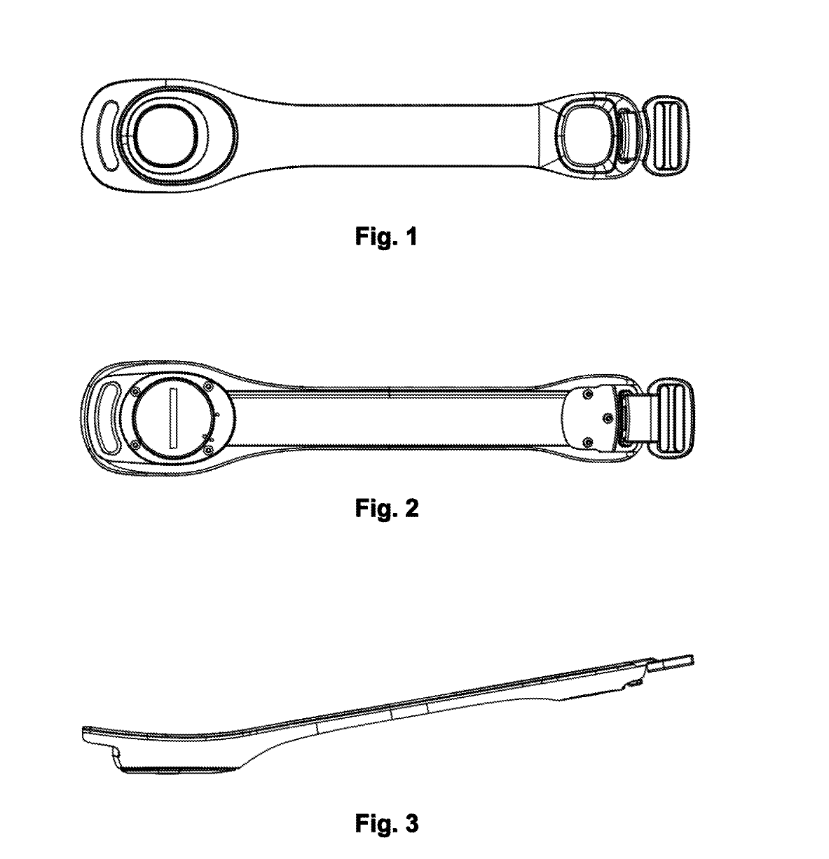

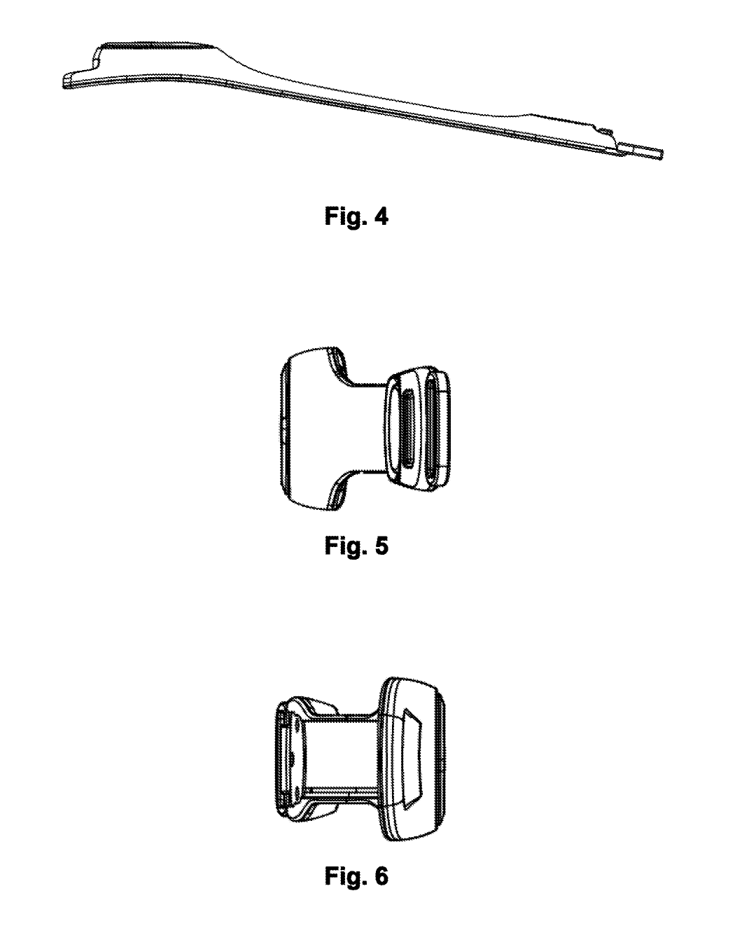

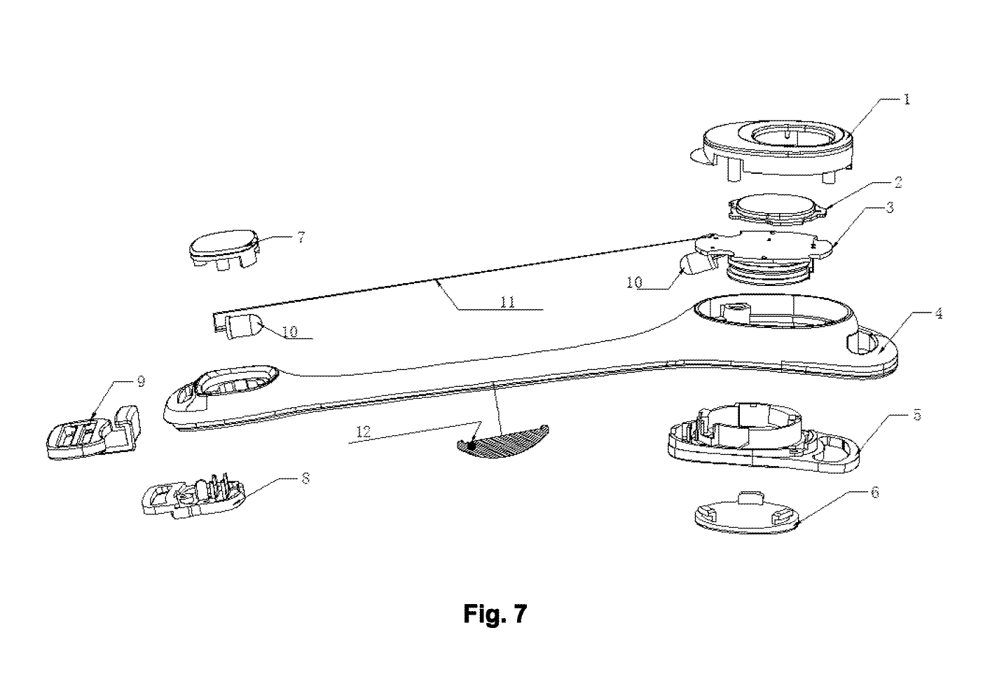

### DETAILED DESCRIPTION OF THE PREFERRED EMBODIMENTS

The invention is further described below with reference to the accompanying drawings and embodiments.

A safety warning light includes a light-guiding soft plastic body on which a wearing band and an electronic device placing portion are of integrated design and which is mainly composed of PU material, wherein one side of the light-guiding soft plastic body is equipped with a reflective coating, and one end or two ends of the light-guiding soft plastic body are equipped with light sources. The light source is a high-brightness LED light source. The switch of the safety warning light is a soft silica gel button switch.

The battery door of the safety warning light is equipped with a battery door structure which can be opened by a coin. The battery door which can be opened by a coin is preferably a battery door which can be opened by a coin of one-yuan face value.

One end of the safety warning light is equipped with a two-window plastic buckle, and the other end is equipped with Velcro. The front end of the Velcro adopts material with light-reflecting function, that is, exposed part of the Velcro is equipped with light-reflecting material.

The above content is further detailed descriptions of the invention given with reference to the preferred embodiment, and it cannot be assumed that embodiments of the invention are limited to these descriptions. The general skilled personnel in the technical field to which the invention belongs can also perform some simple deductions and replacements on the premise of not departing from the conception of the invention, and these deductions and replacements shall fall within the scope of the claims of the invention.

What is claimed is:

1. A safety warning light, comprising a light-guiding soft plastic body on which a wearing band and an electronic device placing portion are of integrated design and which is mainly composed of PU material, wherein one side of the light-guiding soft plastic body is equipped with a reflective coating, and one end or two ends of the light-guiding soft plastic body are equipped with light sources.

2. The safety warning light according to claim 1, wherein battery door of the safety warning light is equipped with a battery door structure which can be opened by a coin.

3. The safety warning light according to claim 2, wherein the battery door which can be opened by a coin is the one which can be opened by a coin of one-yuan face value.

4. The safety warning light according to claim 1, wherein one end of the safety warning light is equipped with a two-window plastic buckle, and the other end is equipped with Velcro.

5. The safety warning light according to claim 4, wherein front end of the Velcro adopts material with light-reflecting function.

6. The safety warning light according to claim 1, wherein the light source is a high-brightness LED light source.

7. The safety warning light according to claim 6, wherein battery door of the safety warning light is equipped with a battery door structure which can be opened by a coin.

8. The safety warning light according to claim 7, wherein the battery door which can be opened by a coin is the one which can be opened by a coin of one-yuan face value.

9. The safety warning light according to claim 6, wherein one end of the safety warning light is equipped with a two-window plastic buckle, and the other end is equipped with Velcro.

10. The safety warning light according to claim 9, wherein front end of the Velcro adopts material with light-reflecting function.

11. The safety warning light according to claim 1, wherein switch of the safety warning light is a soft silica gel button switch.

12. The safety warning light according to claim 11, wherein battery door of the safety warning light is equipped with a battery door structure which can be opened by a coin.

13. The safety warning light according to claim 12, wherein the battery door which can be opened by a coin is the one which can be opened by a coin of one-yuan face value.

14. The safety warning light according to claim 11, wherein one end of the safety warning light is equipped with a two-window plastic buckle, and the other end is equipped with Velcro.

15. The safety warning light according to claim 14, wherein front end of the Velcro adopts material with light-reflecting function.

16. The safety warning light according to claim 6, wherein switch of the safety warning light is a soft silica gel button switch.

17. The safety warning light according to claim 16, wherein battery door of the safety warning light is equipped with a battery door structure which can be opened by a coin.

18. The safety warning light according to claim 17, wherein the battery door which can be opened by a coin is the one which can be opened by a coin of one-yuan face value.

19. The safety warning light according to claim 16, wherein one end of the safety warning light is equipped with a two-window plastic buckle, and the other end is equipped with Velcro.

20. The safety warning light according to claim 19, wherein front end of the Velcro adopts material with light-reflecting function.
